(19) United States
(12) Patent Application Publication
(10) Pub. No.: US 2017/0150847 A1
(43) Pub. Date: Jun. 1, 2017

(54) BBQ Grill Equipped with a Removable Fan

(71) Applicant: Peiying Feng, Zhongshan City (CN)

(72) Inventor: Peiying Feng, Zhongshan City (CN)

(21) Appl. No.: 15/204,539

(22) Filed: Jul. 7, 2016

(30) Foreign Application Priority Data
Nov. 27, 2015 (CN) 201520969298.7

(51) Int. Cl. A47J 37/07

(52) U.S. Cl. CPC A47J 37/0754

(57) ABSTRACT

A barbeque grill equipped with a removable fan, includes a grill body, the barbeque grill body including a housing, a combustion chamber, a grid, and a fan assembly. A heat collection liner is provided inside the housing, the combustion chamber is provided inside the heat collection liner, the grid is provided above the housing, and the fan assembly is provided on the housing via a removable structure, and connected with the combustion chamber via an air channel The fan assembly controls the speed of air flow in the combustion chamber, such that the grill can operate normally under the condition of calm or lack of air flow, and the fan assembly can be removed to be used as a handheld fan, to meet different requirements of blowing and heat dissipation.

### CROSS-REFERENCE TO RELATED APPLICATION

This application claims priority to Chinese Patent Application No. 201520969298.7 filed Nov. 27, 2015, the disclosure of which is hereby incorporated in its entirety by reference.

### FIELD OF THE INVENTION

This application relates to a BBQ (barbeque) grill, especially to a barbeque grill equipped with a removable fan.

### BACKGROUND OF THE INVENTION

The traditional barbeque grill adopts a structure of stove body and support, an air hole is opened at the bottom of the stove body, charcoal is directly placed in the stove body, a grid is supported on the top of the stove body, and the thermal power and efficiency of combustion are controlled by the air hole, however, this kind of traditional barbeque grill depends on the natural air flow too much, under the condition of calm or lack of airflow, the efficiency of combustion is too low due to the low efficiency of air guiding.

### SUMMARY OF THE INVENTION

In order to overcome the deficiencies of the prior art, this utility model provides a barbeque grill equipped with a removable fan.

A technology solution to solve the technical problem by this utility model shall be that:

A barbeque grill equipped with a removable fan, comprising a barbeque grill body, said barbeque grill body comprises a housing, a combustion chamber, a grid and a fan assembly, a heat collection liner is provided inside said housing, said combustion chamber is provided inside said heat collection liner, said grid is provided above the housing, and said fan assembly is provided on the housing via a removable structure and connects with the combustion chamber via an air channel

Said fan assembly comprises a fan housing and the fan provided inside the fan housing, multiple clamping hooks are provided on the fan housing, a related slot corresponding to the fan housing is opened on the bottom of said housing, and related clamping hook hole(s) corresponding to said clamping hooks is opened on the slot wall of said slot.

Said air channel is provided on the fan housing and is corresponding to the fan.

Said fan housing is equipped with power supply assembly, the power supply assembly is a battery box, and said battery box can supply power to the fan.

Said power supply assembly also comprises a USB power supply circuit, the USB power supply circuit can supply power to the fan or battery box, and a Micro USB or Mini USB interface connected with the USB power supply circuit is provided on an end surface of the fan housing.

The power supply assembly comprises a speed governing circuit, a speed governing knob connected with the speed governing circuit is provided on an end surface of fan housing.

Said combustion chamber is of a barrel shape structure, which comprises a barrel body, an upper cover capable of covering on the top of the barrel body, a lower cover provided on the bottom of the barrel body, and a division board provided inside the barrel body, an air distribution cavity is formed between the division board and the lower cover, multiple air distribution holes are opened on the division board, an air channel hole is opened on the lower cover such that the air channel can pass through, and multiple heat conduction holes are opened on the upper cover.

An ash baffle corresponding to the upper cover is provided in the middle of the grid.

The upper cover is provided fixedly under the grid.

A quickdraw means is provided on one side of the housing, and said grid is buckled on the top of the housing via the quickdraw means.

In one embodiment, a barbeque grill equipped with a removable fan, includes a housing, a combustion chamber, a grid, and a fan assembly; a heat collection liner is provided inside the housing, the combustion chamber is provided inside the heat collection liner, the grid is provided above the housing, and the fan assembly is provided on the housing via a removable structure such as a clamping hook structure, quickdraw structure, and slide structure, etc. and connected with the combustion chamber via an air channel, the fan assembly controls the speed of air flow in the combustion chamber, so that this utility model can operate normally even under the condition of calm or lack of airflow, and the fan assembly can be removed to be used as a handheld fan, in order to meet different requirements of blowing and heat dissipation, with stronger functionality.

### BRIEF DESCRIPTION OF THE DRAWINGS

This application will be further specified based on attached drawings and embodiments below.

FIG. 1 is a structure schematic of this utility model;

FIG. 2 is an exploded view of this utility model;

FIG. 3 is an exploded view of the fan assembly of this utility model.

### DETAILED DESCRIPTION OF THE EMBODIMENTS

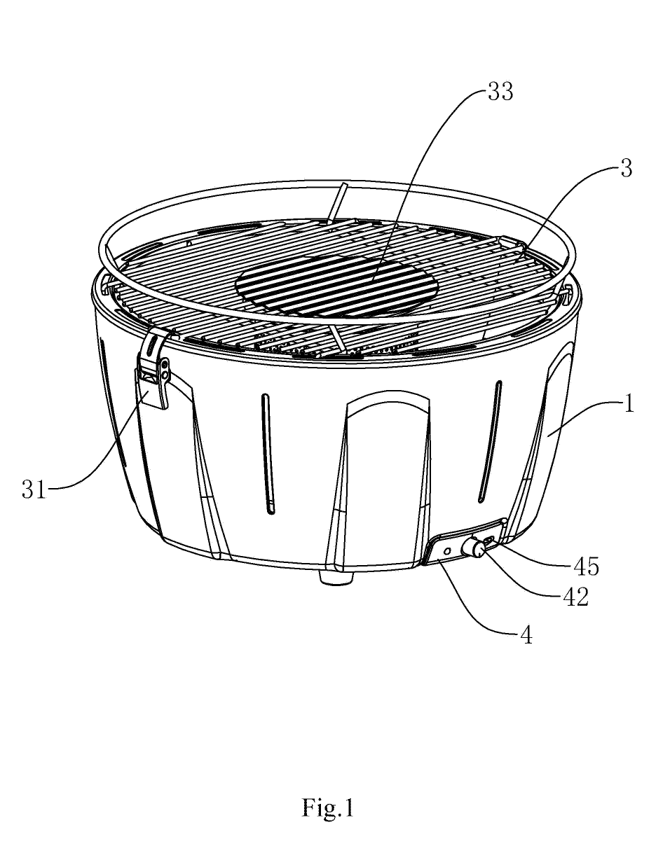

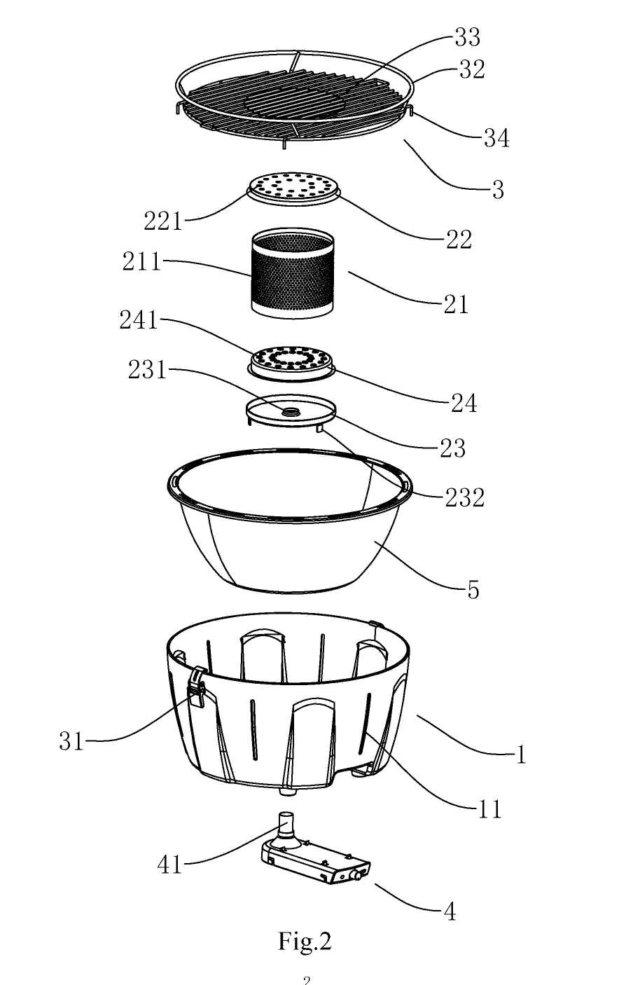

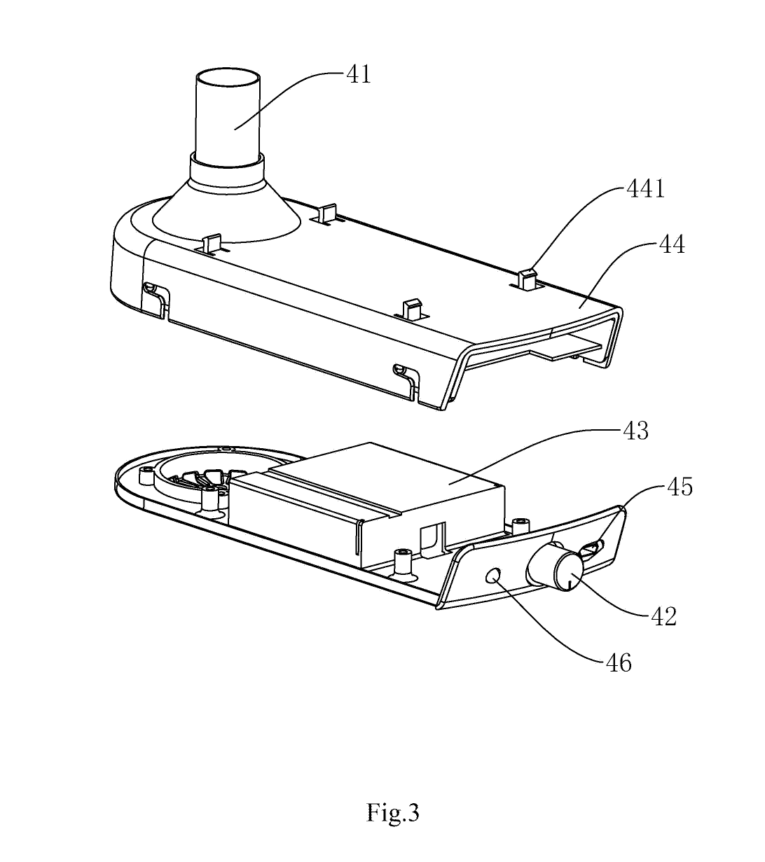

Now referring to FIG. 1 to FIG. 3, FIG. 1 and FIG. 2 are the structure schematic of an embodiment of this utility model, as shown in the drawings, a barbeque grill equipped with a removable fan, which comprises a barbeque grill body, the barbeque grill body comprises a housing 1, a combustion chamber, a grid 3, and a fan assembly 4; a heat collection liner 5 is provided inside the housing 1, the combustion chamber is provided inside the heat collection liner 5, the grid 3 is provided above the housing 1, and the fan assembly 4 is provided on the housing 1 via a removable structure such as a clamping hook structure, quickdraw structure, and slide structure, etc. and connected with the combustion chamber via an air channel 41, the fan assembly 4 controls the speed of air flow in the combustion chamber, so that this utility model can operate normally even under the condition of calm or lack of airflow, and the fan assembly can be removed to be used as a handheld fan, in order to meet different requirements of blowing and heat dissipation, with stronger functionality.

As a preferred embodiment, in this embodiment, the fan assembly 4 comprises a fan housing 44 and a fan provided inside the fan housing 44, the fan can be an axial flow fan or a turbine fan, multiple clamping hooks 441 are provided on the fan housing 44, a slot 11 corresponding to the fan housing 44 is opened at the bottom of the housing 1, clamping hook holes corresponding to the clamping hook 441 are provided on the slot wall of the slot 11, the fan assembly 4 can be quickly assembled and disassembled by the cooperation of the clamping hook 441 and the clamping hook hole.

As a preferred embodiment, the air channel 41 is provided on the fan housing 44 and is corresponding to the fan.

As a preferred embodiment, the fan housing 44 is equipped with a power supply assembly, the power supply assembly is a battery box 43, AA, AAA or other battery/storage battery can be installed in the battery box 43, the battery box 43 can supply power to the fan, for the convenience of outdoor barbeque and portability.

As a preferred embodiment, the power supply assembly also comprises a USB power supply circuit, the USB power supply circuit can supply power to the fan or the battery box 43, a Micro USB interface 45 or Mini USB interface connected with the USB power supply circuit is provided on an end surface of the fan housing 44, with a charging/power indicator 46 provided, which is corresponding to the charging interface of most current cellphones, in which way, it is very convenient to charge.

As a preferred embodiment, the power supply assembly comprises a speed governing circuit, a speed governing knob 42 connected with the speed governing circuit is provided on an end surface of the fan housing 44, which can precisely control the air flow, thus to control the thermal power very well, in which way, different barbecue effects can be achieved, the speed governing circuit can be configured according to the specific different motor of fan, such as DC motor speed governing circuit, server motor speed governing circuit, stepper motor speed governing circuit, inverter motor speed governing circuit, etc., the above-mentioned speed governing circuits are all known in the technical field of motor speed governing circuit, and the USB power supply circuit is also known to a person skilled in the electronics field, which will not be specified in more detail hereby.

As shown in the drawings, the combustion chamber is of a barrel shape structure, which comprises a barrel body 21, an upper cover 22 capable of covering on the top of the barrel body 21, a lower cover 23 capable of covering on the bottom of the barrel body 21, and a division board 24 provided inside the barrel body 21, an air distribution cavity is formed between the division board 24 and the lower cover 23, multiple air distribution holes 241 are opened on the division board 24, an air channel hole 231 is opened on the lower cover 23 such that the air channel 41 can pass therethrough, and multiple heat conduction holes 221 are opened on the upper cover 22, in this embodiment, the air channel 41 is of a tubular structure, the air flow generated by the fan 4 enters into the air distribution cavity via air channel 41, the air is uniformly distributed into the combustion chamber via the air distribution hole 241, to improve the efficiency of combustion, and the division board 24 also has the function of separating the charcoal residue, to avoid the charcoal residue blocking the air channel 41.

As shown in the drawings, multiple heat radiation holes 211 are opened on the barrel body 21, to spread the heat from circumference of the barrel body 21, with certain of diversion function, to improve the efficiency of combustion, further, a heat collection liner 5 is provided inside the housing 1, the combustion chamber is provided inside the heat collection liner 5, the heat collection liner 5 is of an upward heat collection structure that is cone-shaped or pot-shaped, which can radiate the heat to grid 3 on the top of the housing 1 very well, to reduce heat loss and improve heat efficiency, in addition, by separating the heat radiation effectively by the heat collection liner 5, the temperature of housing 1 is reduced, to avoid scalding, and multiple stand bars 232 are provided on the bottom of the lower cover 23, to avoid contact between the combustion chamber and the heat collection liner 5, in which way, to reduce the speed of heat spreading.

As shown in the drawing, multiple heat conduction holes 221 are provided on the upper cover 22, and heat is spread to the grid 3 by the heat conduction holes 221, and an ash baffle 33 corresponding to the upper cover 22 is provided in the middle of the grid 3, the ash baffle 33 blocks the smoke and ash generated from combustion, and returns the smoke and ash to the heat collection liner 5, and generally there is oil on the heat collection liner 5, ash and smoke is adhered to the heat collection liner 5, to avoid the smoke and ash generated from combustion to be adhered on the food, in which way, the effect of no smoke and no ash can be achieved.

In one embodiment, the upper cover 22 is arranged under the grid 3 fixedly via adhesive bonding, welding or threaded connection, etc., so that the upper cover 22 can be taken out in the same time while the grid 3 is taken out, in order to put charcoal in or clean the charcoal residue by taking out the upper cover 22, avoiding scald.

In one embodiment, a quickdraw means 31 is provided on one side of the housing 1, the grid 3 is buckled on the top of the housing 1 via the quickdraw means 31, for the convenience of withdrawing and cleaning the grid or adding charcoal or cleaning charcoal residue.

In one embodiment, an enclosure 32 is provided on the edge of the grid 3, to avoid food accidentally sliding out, and to avoid the unintended touching by hand, and a bending rod 34 corresponding to the outer contour of the housing 1 and bending downward is provided on the edge of the grid 3, to avoid the grid 3 accidentally sliding and deviating.

In one embodiment, multiple heat dissipation holes 11 are opened on the housing 1, to improve the heat emission efficiency of the housing 1, and to further reduce the temperature of the housing 1, in which way, to avoid scalding.

The preferred embodiments of this utility model are described above in detail, of course the invention is not limited to the above-mentioned embodiments, and those skilled in the art can make equivalent variations or replacements without departing from the spirit of the invention, and these equivalent variations or replacements shall all fall within the scope limited by the claims of the application.

What is claimed is:

1. A barbeque grill equipped with a removable fan, comprising: a barbeque grill body having a housing, a combustion chamber, a grid, and a fan assembly;
a heat collection liner provided inside said housing, said combustion chamber provided inside the heat collection liner, and said grid provided above the housing,
wherein the fan assembly is provided on the housing via a removable structure and connected with the combustion chamber via an air channel.

2. The barbeque grill equipped with a removable fan according to claim 1, wherein the fan assembly further comprises a fan housing and a fan provided inside the fan housing, multiple clamping hooks provided on the fan housing, a related slot corresponding to the fan housing is opened on the bottom of the housing, and related clamping hook holes corresponding to the clamping hooks are opened on the slot wall of the slot.

3. The barbeque grill equipped with a removable fan according to claim 2, wherein the air channel is provided on the fan housing and communicates with the fan assembly.

4. The barbeque grill equipped with a removable fan according to claim 2, wherein the fan housing is equipped with a power supply assembly to supply power to the fan.

5. The barbeque grill equipped with a removable fan according to claim 4, wherein the power supply assembly comprises a USB power supply circuit, the USB power supply circuit can supply power to the fan or a battery box.

6. The barbeque grill equipped with a removable fan according to claim 5, further comprising a Micro USB or Mini USB interface connected with the USB power supply circuit is provided on an end surface of the fan housing wherein the power supply assembly comprises a speed governing circuit, and a speed governing knob connected with the speed governing circuit provided on an end surface of fan housing.

7. The barbeque grill equipped with a removable fan according to claim 1, wherein the combustion chamber is barrel shaped and comprises a barrel body, an upper cover capable of covering on the top of the barrel body, a lower cover provided on the bottom of the barrel body, and a division board provided inside the barrel body;
the grill further comprises an air distribution cavity formed between the division board and the lower cover, and multiple air distribution holes are opened on the division board, an air channel hole is opened on the lower cover such that the air channel can pass therethrough, and multiple heat conduction holes are opened on the upper cover.

8. The barbeque grill equipped with a removable fan according to claim 7, wherein an ash baffle corresponding to the upper cover is provided in the middle of the grid.

9. The barbeque grill equipped with a removable fan according to claim 8, wherein the upper cover is provided under the grid.

10. The barbeque grill equipped with a removable fan according to claim 1, wherein a quickdraw apparatus is provided on one side of the housing, and the grid is secured on the top of the housing via the quickdraw apparatus.
